(19) United States
(12) Patent Application Publication
(10) Pub. No.: US 2026/0109902 A1
(43) Pub. Date: Apr. 23, 2026

(54) PROCESS AND INSTALLATION FOR CATALYTICALLY CONVERTING PLASTIC MATERIALS INTO PYROLYTIC OILS

(71) Applicant: VALOREGEN SAS, DAMAZAN (FR)

(72) Inventors: Amélie VALETTE, DAMAZAN (FR); Thierry PEREZ, CAUBEYRES (FR)

(73) Assignee: VALOREGEN SAS, DAMAZAN (FR)

(21) Appl. No.: 19/115,410

(22) PCT Filed: Sep. 27, 2023
(86) PCT No.: PCT/FR2023/051487

§ 371 Date: Mar. 26, 2025

(30) Foreign Application Priority Data
Sep. 28, 2022 (FR) FR22/09818

(51) Int. Cl. C10B 53/07; B01D 45/16; B01D 46/58; B01D 50/20; C10B 57/06; C10B 57/08; C10B 57/14; C10B 57/16; C10G 1/02; C10J 3/84; C10K 1/02; C10K 1/04

(52) U.S. Cl. CPC C10B 53/07; B01D 45/16; B01D 46/58; B01D 50/20; C10B 57/06; C10B 57/08; C10B 57/14; C10B 57/16; C10G 1/02; C10J 3/84; C10K 1/024; C10K 1/026; C10K 1/04; C10G 2300/1003

(57) ABSTRACT

A process for converting plastic materials into pyrolytic oils, wherein: plastic materials are continuously fed into a preheating reactor to be mixed and preheated at a preheating temperature to obtain a pasty mixture; the pasty mixture is continuously transferred into a pyrolysis reactor to be heated at a pyrolysis temperature, under an anaerobic or inert atmosphere, to be converted into synthesis gases and a solid reaction product; the synthesis gases, containing condensable gases and uncondensable gases, are recovered on a first outlet located above the permeable bed, and the solid reaction product is recovered on a second outlet located below the permeable bed; the condensable gases of the synthesis gases are condensed into pyrolytic oils which are recovered.

### TECHNICAL FIELD

The invention relates to a conversion process implementing degradation by pyrolysis of plastic materials for conversion into pyrolytic oils, as well as to an associated conversion installation.

It relates more particularly to a process using catalytic and/or thermal pyrolysis for the chemical recycling of plastic materials, making it possible to produce pyrolytic oils by condensation of the synthesis gases obtained during the catalytic and/or thermal pyrolysis reaction.

The invention thus finds a preferred, and non-limiting, application for the recycling of plastic materials, and in particular plastic material waste, in order to produce pyrolytic oils which will make it possible to produce plastic, thus making the invention part of a so-called “Plastic to Plastic” sector, in other words of a circular economy of plastics.

### PRIOR ART

In a known manner, there are various processes such as gasification, pyrolysis, solvolysis and depolymerization, for degrading the plastic materials, in order to obtain chemical products with lower molar masses, such as pyrolytic oils. Pyrolysis consists of a degradation, or cracking, of polymer molecules subjected to a high temperature (generally between 300 and 900° C.) to obtain smaller molecules, in the absence of oxygen, with a catalyst (so-called catalytic pyrolysis) or without a catalyst (so-called thermal pyrolysis).

However, there is a need to carry out catalytic and/or thermal pyrolysis for the production of pyrolytic oils on an industrial scale and continuously, without a transient regime likely to adversely affect the quality of the pyrolytic oils.

### SUMMARY OF THE INVENTION

Also, one aim of the invention is to propose a conversion process and installation which allow continuous operation for the production of qualitative pyrolytic oils from a heterogeneous quality of plastic materials.

To this end, the invention proposes a conversion process implementing degradation by pyrolysis of plastic materials for conversion into pyrolytic oils, this conversion process comprising at least the following phases:
the plastic materials are continuously fed into a preheating reactor in order to be mixed and preheated at a preheating temperature to fluidize them, and a catalyst is continuously fed into the preheating reactor to be mixed with the plastic materials and obtain a pasty mixture, the preheating temperature being lower than an activation temperature of the catalyst:
the pasty mixture is continuously transferred into a pyrolysis reactor to be heated at a pyrolysis temperature, higher than the preheating temperature and the activation temperature of the catalyst, under an anaerobic or inert atmosphere in order to be converted into synthesis gases and a solid reaction product containing at least chars, the pasty mixture descending by gravity inside the pyrolysis reactor and through a permeable bed which is heated at the pyrolysis temperature;
the synthesis gases, containing condensable gases and non-condensable gases, are recovered on a first outlet of the pyrolysis reactor located above the permeable bed, and the solid reaction product is recovered on a second outlet of the pyrolysis reactor located below the permeable bed;
the condensable gases of the synthesis gases are condensed into pyrolytic oils which are recovered.

Thus, the invention proposes to preheat the plastic materials to the preheating temperature, while mixing them with the catalyst, then to continuously heat and crack the fluidized plastic materials at the pyrolysis temperature.

The preheating in the preheating reactor provides two particularly advantageous functions: the first function is to transmit a significant amount of energy to the plastic materials to change physical state and end up in a pasty state before the pyrolysis reactor, thus promoting the chemical cracking reaction; and the second function is to fluidize and homogenize the plastic materials (with the change of physical state between initially solid plastic materials, which will be fluidized in the preheating reactor), which will then come into contact with the permeable bed having a large heat exchange surface with plastic materials falling (or flowing) by gravity through this permeable bed.

Furthermore, these fluidized plastic materials are mixed with the catalyst inside the preheating reactor. In other words, the plastic materials are continuously fed into the preheating reactor in order to be mixed and preheated at the preheating temperature to fluidize them and these plastic materials are mixed at the same time with the catalyst inside the preheating reactor in order to obtain a pasty and homogeneous mixture.

Thus the pasty mixture, at the outlet of the preheating reactor, is a miscible and homogeneous mixture of the plastic materials and the catalyst, and the solid reaction product obtained in the pyrolysis reactor contains the chars but also the catalyst; the mixture of the plastic materials and the catalyst being made miscible thanks to the preheating in the preheating reactor.

By doing so, by introducing and mixing the catalyst in the preheating reactor, a homogeneous mixture in a pasty state is obtained, because the catalyst is homogeneously dispersed in the fluidized plastic materials, which will promote the selectivity in cutting polymer chains into molecules of higher molecular weight, and therefore improve the quality of the pyrolytic oil in accordance with the requirements of the “Plastic to Plastic”sector.

The activation temperature of the catalyst corresponds to the temperature from which the catalyst is activated and chemically promotes the pyrolysis reaction.

The catalyst, for example of the zeolite type, makes it possible to reduce the working temperatures in the pyrolysis reactor and the activation energies required to initiate the pyrolysis or cracking reaction without disturbing the shape of the reaction products. A simultaneity of the thermal effect and the catalytic effect takes place when the catalyst mixed with the plastic materials is introduced directly into the pyrolysis reactor. The catalyst thus allows optimization of the overall yield to promote recoverable oil fractions. The catalyst allows a selectivity of the reaction products and obtaining a cut of carbon chains in order to achieve the desired oil quality and the required properties.

The introduction of the plastic materials and the catalyst, in a pasty state and homogeneously mixed, into the pyrolysis reactor makes it possible to optimize the contact with the heated permeable bed which provides the energy capacity initiating the reaction of cracking plastic materials into synthesis gas (also called “syngas”).

It should be noted that the pyrolysis reaction occurs, in an anaerobic atmosphere (in the absence of oxygen) or under an inert atmosphere, with a fixed and stable pyrolysis temperature. This pyrolysis reaction takes place during the simultaneous contact of the fluidized plastic materials, mixed with the catalyst, and the heated permeable bed within the pyrolysis reactor, leading to the chemical cracking reaction and therefore the depolymerization of the plastic materials. The use of a pyrolysis reactor in the form of a gravity column into which the plastic materials fall, significantly increases the contact time between the incoming plastic materials and the heated permeable bed.

This process allows a dissociation of the activation energy supply to the plastic materials, between the energy supply in the preheating reactor and the energy supply in the pyrolysis reactor, in order to optimize the plastic material cracking reaction. Indeed, this dissociation of the energy supply makes it possible to segment the working temperatures according to the reactor considered and to work on a constant and stable temperature range within the pyrolysis reactor and therefore to obtain a selective cut of the carbon chains present in the pyrolytic oils.

Thus, the process makes it possible to have:
a first activation energy supply, in the preheating reactor, over a temperature range between 20 and 290° C., up to 40 to 70% of the total energy required to carry out the pyrolysis reaction; and
a second activation energy supply, in the pyrolysis reactor, over a temperature range between 300 and 900° C., up to 30 to 60% of the energy required to initiate the pyrolysis reaction.

Thus, a large amount of the activation energy required for the pyrolysis reaction is supplied into the preheating reactor, the pyrolysis reactor thus having to provide less energy to make it possible to crack the plastic materials.

In addition, the synthesis gases (also called “syngas”), produced during the thermal and/or catalytic cracking of the plastic materials, are extracted on the first outlet, above the permeable bed, in order to promote the settling of the chars within the pyrolysis reactor and avoid the transfer of the chars to the synthesis gas recovery line. This extraction of synthesis gases above the permeable bed is also explained in the case of a partial cracking reaction due to the possibility of different energies supplied between the bottom and the top of the pyrolysis reactor (for example due to heterogeneity of the different types of plastics). Also, this extraction of gases makes it possible to limit, or even avoid, the clogging of the synthesis gas recovery line.

According to a feature, the plastic materials are in the form of granules or flakes whose dimensions are at most 15 to 25 millimeters.

Advantageously, a step of degassing the pasty mixture is implemented inside the preheating reactor.

This degassing step consists in degassing, in other words extracting the gases dissolved and/or included in the plastic materials during fluidization, and in particular the air included in the plastic materials upstream of the preheating reactor and the air incorporated in the plastic materials inside the preheating reactor during its fluidization, as well as volatile organic compounds (VOCs). The interest is twofold, namely to avoid, or at least reduce, the introduction of air inside the pyrolysis reactor, and also to remove contaminants such as volatile organic compounds (VOCs) which would adversely affect the quality of the pyrolysis oil.

For pyrolysis oil to be compatible with the “Plastic to Plastic” sector, it is necessary that the molecules of which it is composed make it possible to remanufacture plastic of the same nature as those used to produce the oil. Pyrolysis oil must therefore contain a low contaminant content, as too high levels would result in incompatibility of the pyrolysis oil with industrial processes for remanufacturing plastic from oil. Thus, this degassing step will promote the removal, before pyrolysis, of contaminants such as volatile organic compounds and therefore contribute to improving the quality of the pyrolytic oil to be compatible with the requirements of the “Plastic to Plastic”sector.

This degassing step can be carried out by an air pump, such as a vacuum pump, in connection with the preheating reactor.

According to a possibility of the process, before being introduced inside the preheating reactor, the plastic materials are dry washed inside an inlet centrifuge, with air heated at a drying temperature lower than the preheating temperature.

The advantages of this dry washing by centrifugation and hot air are to eliminate the moisture present in the plastic materials, and to extract the contaminants accompanying the plastic materials, such as cellulosic type waste, inert waste, metal pieces. This step thus makes it possible to reduce the impacts of these contaminants on the quality of the pyrolytic oils.

In other words, this dry washing by centrifugation upstream of the preheating reactor promotes the extraction of pollution sources for the pyrolytic oils, which would make them incompatible with the oil treatment facilities existing today and used for the treatment of natural resources and for the manufacture of plastics as part of the “Plastic to Plastic”sector.

This washing of plastics in a centrifuge upstream of the preheating reactor is therefore an important step in the process with the aim of producing qualitative pyrolytic oils in order to remanufacture plastics that meet the requirements of this “Plastic to Plastic” sector, that is to say as part of the circular economy of plastics.

According to another possibility of the process, before being introduced into the preheating reactor, the plastic materials are introduced into a cyclone (for example by means of an aeraulic system) having a base provided with a discharge outlet connected to the preheating reactor.

Such a cyclone has a dual function: the first function is to extract the amount of air included in the plastic materials upstream of the preheating reactor, and the second function consists in conveying the plastic materials within the preheating reactor. Furthermore, a bed of granules or flakes of plastic materials is formed at the base of the cyclone generating a plug, on its discharge outlet, and thus avoiding the introduction of air into the preheating reactor.

According to another possibility, inside the preheating reactor, the plastic materials are mixed by means of a worm screw.

Such a worm screw is advantageous for homogenizing the heated plastic materials within the pasty mixture.

According to a feature, the preheating temperature is comprised between 20 and 290° C. inside the preheating reactor.

It should be noted that this preheating makes it possible to supply, through heat, the energy required for the plastic materials to change state and pass from a solid aspect to a pasty state, with the aim in particular of facilitating the homogenization of the plastic materials with the catalyst. This energy supply provides the mixture (plastic materials and catalyst) with a portion of the total energy required for the pyrolysis reaction (between 40 and 70% of the total energy) which will take place in the pyrolysis reactor. The preheating step therefore allows a dissociation of the energies involved during the reactions between the plastic materials and the catalyst.

The selectivity of the catalyst and the management of temperatures in the preheating reactor and in the pyrolysis reactor thus make it possible to control the pyrolysis reaction in the pyrolysis reactor in order to obtain an oil quality corresponding to the requirements of the “Plastic to Plastic”sector.

In a particular embodiment, inside the preheating reactor, the plastic materials are preheated by means of a heat transfer fluid present or circulating in a double jacket of the preheating reactor.

Advantageously, the heat transfer fluid of the preheating reactor is heated by a burner fed at least partially with the non-condensable gases of the synthesis gases recovered on the first outlet of the pyrolysis reactor.

Thus, these non-condensable gases, products of pyrolysis, are used directly in the process, thus offering energy savings.

In a particular embodiment, between the preheating reactor and the pyrolysis reactor, the pasty mixture passes into a material diffuser heated at a diffusion temperature higher than the preheating temperature.

If necessary, this diffusion temperature is lower than the activation temperature of the catalyst.

Such a material diffuser makes it possible to achieve a homogeneous and uniform surface distribution of the pasty mixture on the permeable bed present in the pyrolysis reactor, in order to benefit from the entire energy capacity of the surfaces offered by the permeable bed. This uniform diffusion of the incoming pasty material makes it possible to avoid a preferential flow path and promotes the residence time of the plastic materials in contact with the heated permeable bed, to improve the heat transfer during the pyrolysis reaction.

This material diffuser therefore has several functions. The first function consists in heating the mixture entering the diffuser to temperatures higher than those used in the preheating reactor, with the aim of transferring a maximum of energy in the form of heat from the diffuser to the material and thus increase the energy supply within the material promoting the cracking reactions with the catalyst that will take place in the pyrolysis reactor. The second function is to allow a homogeneous and uniform surface distribution of the material on the permeable bed present in the pyrolysis reactor. The third and final function is to link the preheating reactor to the pyrolysis reactor by means of this material diffuser, which can for example take the form of a high-temperature sleeve, so as to ensure sealing of the process.

According to a variant, the diffuser and the pyrolysis reactor are connected by a high-temperature sleeve, in order to be able to manage the expansions related to the temperature differences and promote sealing between the diffuser and the pyrolysis reactor.

According to a possibility, the permeable bed is subjected to vibration.

Such vibration promotes the detachment of the chars, and possibly of the catalyst, present on the permeable bed, and therefore their discharge downwards by gravitational descent within the pyrolysis reactor.

According to another possibility, the permeable bed is a fixed bed.

According to a feature, the permeable bed is formed of a lattice composed of meshes delimiting holes, for example made of heat-resistant steel or ceramic.

In an advantageous embodiment, the permeable bed is heated by means of a heat transfer fluid present or circulating inside the meshes which are tubular.

Advantageously, the heat transfer fluid of the permeable bed is heated by a burner fed at least partially with the non-condensable gases of the synthesis gases recovered on the first outlet of the pyrolysis reactor; which contributes to a relative or at least partial energy autonomy of the process.

Alternatively or additionally, the pyrolysis reactor is heated at the pyrolysis temperature by means of a heat transfer fluid present or circulating in a double jacket, this heat transfer fluid being heated by a burner fed at least partially with the non-condensable gases of the synthesis gases recovered on the first outlet of the pyrolysis reactor.

According to a variant, the permeable bed consists of heat transfer media, for example made of heat-resistant steel or ceramic.

Advantageously, the pyrolysis reactor is a narrow and long reaction column (height at least ten times greater than the width or diameter) allowing a significant residence time of the plastic materials, and if necessary of the catalyst, on the permeable bed in order to have an optimal pyrolysis reaction. The choice of a reaction column makes it possible to manage the flow of the material within the pyrolysis reactor to meet a large exchange surface with the permeable bed and ensure a homogeneous distribution, in terms of height and linear distribution, with the aim of avoiding “arching”. The use of a reaction column in which the plastic materials descend by gravity, over a great height, significantly increases the contact time between the plastic materials and the permeable bed.

According to a feature, the pyrolysis temperature is stable and comprised between 300 and 900° C.

Pyrolysis is thus presented as a continuous pyrolysis at a constant working temperature (called pyrolysis temperature) over a given range allowing the cracking of the plastic materials while obtaining a constant quality of pyrolytic oils; the pyrolysis reactor making it possible to work at a constant pyrolysis temperature in order to avoid a temperature gradient within the pyrolysis reactor and, if necessary, to manage the working range of the catalyst.

Indeed, managing the pyrolysis temperature under isothermal conditions (that is to say at a stable pyrolysis temperature) has an impact on the quality of the pyrolytic oils obtained so that they are compatible with the “Plastic to Plastic” sector. Indeed, the catalyst can be used and is effective in a well-defined and specific temperature range. Under these conditions, it is therefore advantageous to work with a stable pyrolysis temperature (isothermal condition) in order to master the selectivity of the carbon chain cuts thanks to the catalyst used and thus obtain the desired chemical distribution of the molecules formed in the pyrolytic oils during the pyrolysis reactions.

These chain cuts will have an impact on the quality of the pyrolytic oils and the catalyst, in the context of an adapted and constant pyrolysis temperature, makes it possible to cut the polymer chains in a controlled and oriented manner in order to obtain pyrolytic oils of homogeneous quality. Thus, this feature relating to a stable pyrolysis temperature within the pyrolysis reactor makes it possible to promote the production of pyrolysis oils allowing producing plastics as part of the circular economy of plastics.

According to a variant, pyrolysis is a “flash” pyrolysis transforming the plastic materials into synthesis gases in a duration of less than 1 second, or even in the range of 0.01 seconds.

Advantageously, the solid reaction product, recovered on the second outlet of the pyrolysis reactor, is introduced into a closed regeneration reactor for heating the solid reaction product to a regeneration temperature allowing at least partial regeneration of the catalyst it contains.

According to a feature, inside the closed regeneration reactor, the solid reaction product is heated by means of a heat transfer fluid present or circulating in a double jacket of the closed regeneration reactor.

According to another feature, the heat transfer fluid of the closed regeneration reactor is heated by a burner fed at least partially with the non-condensable gases of the synthesis gases recovered on the first outlet of the pyrolysis reactor; which also contributes to a relative or at least partial energy autonomy of the process.

According to a possibility, the regeneration temperature is comprised between 300 and 900° C.

According to another possibility, at the outlet of the closed regeneration reactor, the solid reaction product is introduced into a separator to perform a separation between the regenerated catalyst and the chars or a mixture containing the chars and non-regenerated catalyst, the regenerated catalyst being reintroduced inside the preheating reactor.

Thus, the catalyst is at least partially regenerated in the closed regeneration reactor, and recovered at the outlet of the separator to be recycled as it is reinjected into the preheating reactor in order to be mixed with the plastic materials.

This step is advantageous because it makes it possible to reuse the catalyst after its regeneration by reintroducing it into the preheating reactor, in order to reduce the economic impact of the catalyst. The non-regenerated catalyst and the chars can undergo treatment outside the scope of the present process.

According to another possibility, before its introduction into the preheating reactor, the regenerated catalyst is mixed with a new catalyst.

According to another possibility, the new catalyst is mixed with the regenerated catalyst in a predefined and controlled proportion by means of a metering screw.

In a particular embodiment, the synthesis gases, recovered on the first outlet of the pyrolysis reactor, are introduced into a filtration unit for filtration of suspended particles contained in the synthesis gases, before condensation of the condensable gases of the synthesis gases.

This advantageous filtration unit thus forms a purification section on the synthesis gas recovery line, in order to separate any impurities from the synthesis gases with the aim of avoiding contamination of the reaction products and also, if necessary, disruption of catalyst effects.

According to a possibility, the synthesis gases are subjected to cyclonic filtration within at least one cyclone of the filtration unit.

The cyclonic function is advantageous for separating dust and suspended char particles from the synthesis gases, in order to eliminate dust and volatile chars with the aim of avoiding potential contamination of the pyrolytic oils.

According to another possibility, the synthesis gases are subjected alternately to cyclonic filtration within a first cyclone of the filtration unit and to cyclonic filtration within a second cyclone of the filtration unit, the at least one cyclone of the filtration unit comprising said first cyclone and said second cyclone in parallel.

Since the plastic pyrolysis process is continuous, it is advantageous to have these two cyclones that are interchangeable and that operate alternately in order to promote maintenance and cleaning cycles; in other words, when one of the cyclones is being cleaned, the other is active in purification mode.

In an advantageous embodiment, after cyclonic filtration, the synthesis gases are subjected to micrometric filtration within at least one micrometric filter of the filtration unit.

Such micrometric filtration makes it possible to carry out finer filtration of the particles and contaminants remaining in the synthesis gases, compared to the cyclone(s). In other words, this micrometric filtration aims to eliminate microparticles not purified by the previous cycloning step.

According to a possibility, the synthesis gases are subjected alternately to micrometric filtration within a first micrometric filter of the filtration unit and to micrometric filtration within a second micrometric filter of the filtration unit, the at least one micrometric filter of the filtration unit comprising said first micrometric filter and said second micrometric filter in parallel.

Since the plastic pyrolysis process is continuous, it is advantageous to have these two micrometric filters that are interchangeable and that operate alternately in order to promote maintenance and cleaning cycles; in other words, when one of the micrometric filters is being cleaned, the other is active in filtration mode.

According to a particular embodiment, the condensable gases of the synthesis gases are successively condensed in at least one primary condenser operating at a primary condensation temperature, then in at least one secondary condenser operating at a secondary condensation temperature, said secondary condensation temperature being lower than the primary condensation temperature.

After the synthesis gas recovery line, and if necessary after filtration, these synthesis gases are condensed, preferably during a flash operation which allows cooling of the synthesis gases at the outlet of the pyrolysis reactor; these synthesis gases comprising non-condensable gases (such as for example carbon monoxide CO, carbon dioxide CO2, methane CH4) and hydrocarbon type condensable gases. These synthesis gases may also contain impurities (minor inorganic compounds e.g.: metals, alkalis, S, Na, . . . ) initially present in the plastic materials.

In this situation, the or one of the primary condenser(s) is traversed by the synthesis gases, which are thus conveyed and cooled in this primary condenser in order to provide a necessary thermal shock between the hot synthesis gases and the cold primary condenser. Condensation of the polymer chains present in the synthesis gases then occurs, in the form of pyrolytic oils and a water fraction, which can then be received in a settling tank.

The proportions of condensing synthesis gases are controlled by regulating the cooling temperature of the primary condenser, called the primary condensation temperature. Preferably, the synthesis gas recovery line, before the primary condenser, is thermally traced to the inlet of the primary condenser(s) with the aim of avoiding premature condensation of the synthesis gases into pyrolytic oils.

A fraction of the condensable gases that has not been condensed in the primary condenser, then passes through the secondary condenser which operates at a lower temperature, thus causing a greater thermal shock than that used for the primary condenser. This double quenching or condensation effect allows a reduction in energy consumption for cooling the synthesis gases. The secondary condenser is advantageous in that it causes condensation of the fraction of non-condensed gases following their passage in the primary condenser. The shortest chains condense in the form of a new fraction of pyrolytic oils, obtained through condensation in the secondary condenser. If necessary, this fraction returns to the settling tank.

The principle of using two successive condensers at two distinct temperatures makes it possible to condense all (or at least a large part) of the condensable gases into pyrolytic oils, thanks to two different condensation temperatures, and thus makes it possible to maximize the conversion into pyrolytic oils.

Also, this double condensation in two successive condensers has several advantages.

The first advantage consists in condensing, in two phases, the condensable fraction of syngas into molecules of the “light” hydrocarbon types so that the pyrolytic oils produced are part of the “Plastic to Plastic” sector and therefore of the circular economy of plastics. Indeed, with the aim of meeting these requirements, the molecules present in the oils must contain short carbon chains, that is to say in the form of liquid at room temperature. The primary condenser makes it possible to condense a certain type of carbon chains in a controlled manner. The non-condensed syngas pass through the secondary condenser whose cooling temperature is colder than that of the primary condenser, allowing condensation of the shortest carbon chains present in the condensable fraction of syngas with the aim of recovering all the condensable products in the form of pyrolytic oil.

The second advantage of this double condensation is to increase the conversion of plastic materials into pyrolytic oils with a quality that meets the requirements of the “Plastic to Plastic” sector in order to obtain the highest possible yield.

The last advantage consists in reducing the energy consumption required during the condensation of syngas by dividing the process with at least two condensers cooled to different temperatures. The temperature of the primary condenser is higher than that of the secondary condenser. The pyrolytic oils obtained under these conditions have a homogenous quality that meets the requirements of the “Plastic to Plastic” sector.

In summary, this double condensation step makes it possible to obtain pyrolytic oils that meet the quality requirements of pyrolytic oils allowing producing plastics as part of the “Plastic to Plastic” sector.

In an advantageous embodiment, before condensation in the at least one secondary condenser, the condensable gases of the synthesis gases are condensed alternately in a first primary condenser and in a second primary condenser, the at least one primary condenser comprising said first primary condenser and said second primary condenser in parallel.

Since the plastic pyrolysis process is continuous, it is advantageous to have these two primary condensers that are interchangeable and that operate alternately in order to promote maintenance and cleaning cycles; in other words, when one of the primary condensers is being cleaned, the other is active in condensation mode.

Advantageously, a vacuum pump, arranged downstream of the at least one secondary condenser, provides suction of the synthesis gases into the at least one secondary condenser and discharge of the non-condensable gases on a non-condensable gas recovery line.

The invention also relates to a conversion installation configured for degradation by pyrolysis of plastic materials for conversion into pyrolytic oils, such a conversion installation comprising at least:
a continuous plastic material feed line;
a catalyst feed line;
a preheating reactor connected to the continuous plastic material feed line and to the catalyst feed line, said preheating reactor being configured to mix the plastic materials and preheat them at a preheating temperature in order to fluidize them, and to mix the plastic materials with the catalyst in order to obtain a pasty mixture, the preheating temperature being lower than an activation temperature of the catalyst:
a pyrolysis reactor arranged downstream of the preheating reactor and configured to heat the pasty mixture at a pyrolysis temperature, higher than the preheating temperature and the activation temperature of the catalyst, under an anaerobic or inert atmosphere in order to be converted into synthesis gases and a solid reaction product containing at least chars, the pyrolysis reactor internally incorporating a permeable bed, a first outlet located above the permeable bed and a second outlet located below the permeable bed;
a synthesis gas recovery line connected to the first outlet of the pyrolysis reactor, the synthesis gases containing condensable gases and non-condensable gases;
a solid reaction product recovery line connected to the second outlet of the pyrolysis reactor;
a condensation line arranged downstream of the synthesis gas recovery line and configured to condense the condensable gases of the synthesis gases into pyrolytic oils.

Thanks to such preheating and mixing of the plastic materials and the catalyst, as described above, a homogeneous and pasty mixture of the plastic materials and the catalyst is obtained.

According to a feature, the continuous plastic material feed line comprises, upstream of the preheating reactor, an inlet centrifuge for dry washing the plastic materials, with air heated at a drying temperature lower than the preheating temperature.

According to another feature, the plastic material feed line comprises, upstream of the preheating reactor, a cyclone having a base provided with a discharge outlet connected to the preheating reactor.

In a particular embodiment, the preheating reactor comprises a worm screw.

According to a possibility, the preheating reactor comprises a double jacket in which a heated heat transfer fluid is present or circulates.

According to another possibility, the preheating reactor is associated with a burner for heating the heat transfer fluid of the preheating reactor, said burner being fed at least partially with the non-condensable gases of the synthesis gases recovered on the synthesis gas recovery line.

In an advantageous embodiment, the installation comprises, between the preheating reactor and the pyrolysis reactor, a material diffuser for a substantially homogeneous and uniform surface distribution of the pasty mixture inside the pyrolysis reactor, said material diffuser being heated at a diffusion temperature higher than or equal to the preheating temperature and lower than the pyrolysis temperature.

According to a particular embodiment, the pyrolysis reactor is associated with a vibrator for subjecting the permeable bed to vibration.

According to a feature, the permeable bed is a fixed bed.

According to another feature, the permeable bed is formed of a lattice composed of meshes delimiting holes, for example made of heat-resistant steel or ceramic.

According to a particular embodiment, the meshes of the permeable bed are tubular and a heated heat transfer fluid is present or circulates inside said meshes.

According to a possibility, the pyrolysis reactor is associated with a burner for heating the heat transfer fluid of the permeable bed and/or for heating a heat transfer fluid circulating or present in a double jacket of the pyrolysis reactor, said burner being fed at least partially with the non-condensable gases of the synthesis gases recovered on the synthesis gas recovery line.

Advantageously, the preheating reactor is connected to an air pump, such as a vacuum pump, for degassing the pasty mixture inside the preheating reactor.

This air pump thus provides a degassing function, in order to extract the air included in the plastic materials upstream of the preheating reactor and during fluidization, and also to extract volatile organic compounds dissolved in the plastic materials, as previously explained.

In an advantageous embodiment, the installation comprises a closed regeneration reactor connected on the second outlet of the pyrolysis reactor, for heating the solid reaction product to a regeneration temperature allowing at least partial regeneration of the catalyst it contains.

According to a feature, the closed regeneration reactor comprises a double jacket inside which a heated heat transfer fluid is present or circulates.

According to another feature, the closed regeneration reactor is associated with a burner for heating the heat transfer fluid of the closed regeneration reactor, said burner being fed at least partially with the non-condensable gases of the synthesis gases recovered on the synthesis gas recovery line.

According to another feature, the installation comprises, at the outlet of the closed regeneration reactor, a separator for performing a separation between the regenerated catalyst and the chars or a mixture containing the chars and non-regenerated catalyst, the separator comprising a first outlet for the regenerated catalyst and a second outlet for the chars or the mixture containing the chars and the non-regenerated catalyst.

According to a particular embodiment, the installation comprises a return line connecting the first outlet of the separator to the catalyst feed line in order to reintroduce the regenerated catalyst inside the preheating reactor.

In a particular embodiment, the catalyst feed line is connected to a new catalyst storage volume in order to mix the regenerated catalyst and the new catalyst before introduction inside the preheating reactor.

According to a feature, the catalyst feed line comprises a metering screw for mixing the new catalyst with the regenerated catalyst in a predefined and controlled proportion.

According to a particular embodiment, the synthesis gas recovery line comprises a filtration unit for filtration of suspended particles contained in the synthesis gases, before condensation of the condensable gases of the synthesis gases in the condensation line.

According to a feature, the filtration unit comprises at least one cyclone for subjecting the synthesis gases to cyclonic filtration.

According to another feature, the at least one cyclone of the filtration unit comprises a first cyclone and a second cyclone in parallel to subject the synthesis gases alternately to cyclonic filtration within the first cyclone and to cyclonic filtration within the second cyclone.

According to another feature, the filtration unit comprises, downstream of the at least one cyclone, at least one micrometric filter for subjecting the synthesis gases to micrometric filtration.

According to another feature, the at least one micrometric filter comprises a first micrometric filter and a second micrometric filter in parallel to subject the synthesis gases alternately to micrometric filtration within the first micrometric filter and to micrometric filtration within the second micrometric filter.

According to a possibility, the condensation line successively comprises at least one primary condenser operating at a primary condensation temperature, and at least one secondary condenser operating at a secondary condensation temperature, said secondary condensation temperature being lower than the primary condensation temperature.

According to another possibility, the at least one primary condenser comprises a first primary condenser and a second primary condenser in parallel to condense the condensable gases of the synthesis gases alternately in the first primary condenser and in the second primary condenser.

In an advantageous embodiment, the installation comprises a non-condensable gas recovery line on which a vacuum pump is arranged downstream of the at least one secondary condenser, for suction of the synthesis gases into the at least one secondary condenser and discharge of the non-condensable gases.

### BRIEF DESCRIPTION OF THE FIGURES

Other features and advantages of the present invention will appear on reading the following detailed description, of two non-limiting examples of implementation, made with reference to the appended figures in which:

FIG. 1 is a schematic view of a part of a plastic pyrolysis installation according to the invention, comprising in particular the plastic material feed line, the catalyst feed line, the preheating reactor and the pyrolysis reactor;

FIG. 2 is a schematic view of another part of the installation of FIG. 1, and in particular of the synthesis gas recovery line and the condensation line;

FIG. 3 is a schematic view of a variant of the other part of FIG. 2.

### DETAILED DESCRIPTION OF ONE OR SEVERAL EMBODIMENTS OF THE INVENTION

With reference to the Figures, a conversion installation 1 is provided for degradation by pyrolysis of plastic materials for conversion of these plastic materials into pyrolytic oils.

The conversion installation 1 comprises a continuous plastic material feed line 2, which conveys the bulk plastic materials and which successively comprises an inlet centrifuge 20 and a cyclone 21.

The inlet centrifuge 20 continuously receives, at the inlet, plastic materials for dry washing the raw plastic materials, which are in the form of granules or flakes whose dimensions are at most 15 to 25 millimeters. The inlet centrifuge 20 is provided for dry washing the plastic materials, with the aim of decontaminating them, with air heated at a given drying temperature, for example in the range of 40 to 80° C. This inlet centrifuge 20 has a discharge 24 for the reflux generated by the washing of the plastic materials.

The cyclone 21 is connected to an outlet of the inlet centrifuge 20 to receive, at the inlet, the washed (or purified of contamination) plastic materials and this cyclone 21 has a base (in the lower part) provided with a discharge outlet 22, as well as a suction mouth in the upper part which is connected to a suction path 23 to suck air into the cyclone 21. Thus an air extraction takes place in this cyclone 21, and a plug of plastic materials is formed at the base of the cyclone 21, thus creating an airtightness on the discharge outlet 22. This cyclone 21 makes it possible to reduce the amount of air included in the plastic materials.

The conversion installation 1 also comprises a catalyst feed line 4 for a continuous feeding of catalyst; the catalyst having a given activation temperature, from which the catalyst is activated to promote the cracking or pyrolysis reaction of the plastic materials. This catalyst feed line 4 is connected to a storage volume 40 in which new catalyst is stored.

The conversion installation 1 comprises a preheating reactor 3 which is continuously fed with plastic materials by the continuous feed line 2, and with catalyst by the catalyst feed line 4. The plastic materials are introduced through a first inlet 30 of the preheating reactor 3, and the catalyst is introduced through a second inlet 37 of the preheating reactor 3. The first inlet 30 and the second inlet 37 can be separate or combined.

The discharge outlet 22 of the cyclone 21 is connected to the first inlet 30 of the preheating reactor 3. According to an advantageous possibility, the discharge outlet 22 of the cyclone 21 is arranged above the first inlet 30 of the preheating reactor 3 for a gravity feed of the plastic materials.

The preheating reactor 3 comprises a heating means and a mixing means for preheating the plastic materials at a preheating temperature in order to fluidize them, and for mixing the plastic materials with the catalyst in order to obtain a pasty, miscible and homogeneous mixture, at an outlet 31 of the preheating reactor 3.

The preheating temperature is higher than a fluidization temperature of the plastic materials in order to produce a phase transition between a solid state and a viscous state. The preheating temperature is lower than the activation temperature of the catalyst, and also the pyrolysis temperature which corresponds to the cracking temperature of the plastic materials. The preheating temperature is for example comprised between 20 and 290° C. inside the preheating reactor 3.

Advantageously, the preheating reactor 3 comprises a worm screw 32, and the introduction of the plastic materials and the catalyst is performed at a first end of this worm screw 32, and the discharge of the pasty mixture is performed at a second end of this worm screw 32, opposite its first end.

This preheating reactor 3 is connected to an air pump 33, such as a vacuum pump, which provides a degassing function, in order to extract the dissolved gases (such as air and volatile organic compounds) in the plastic materials and the air included in the plastic materials upstream of the preheating reactor 3 and during fluidization. The air pump 33 may be followed by one or several filters 34, such as for example a volatile organic compound filter, for filtration and treatment of gases dissolved and included in the plastic materials before release into the atmosphere.

This preheating reactor 3 comprises a double jacket (or sheath) in which a heat transfer fluid heated by a burner 91 is present or circulates; this burner 91 being thus adjusted to heat the heat transfer fluid of the preheating reactor 3 to the preheating temperature.

The conversion installation 1 comprises a material diffuser 35, connected to the outlet 31 of the preheating reactor 3, so that the pasty mixture (comprising, as a reminder, the fluidized plastic materials mixed with the catalyst), is introduced into the material diffuser 35. This material diffuser 35 has the function of ensuring a substantially homogeneous and uniform surface distribution of the pasty mixture at its outlet 36. The material diffuser 35 can be heated at a diffusion temperature higher than or equal to the preheating temperature and lower than the pyrolysis temperature, in order to maintain the pasty mixture in a viscous state. This diffusion temperature can be comprised between 200 and 300° C.

The conversion installation 1 comprises a pyrolysis reactor 5 connected to the outlet 36 of the material diffuser 35; this pyrolysis reactor 5 is therefore arranged downstream of the preheating reactor 3 and it is configured to heat the pasty mixture at a pyrolysis temperature, higher than the preheating temperature and the activation temperature of the catalyst, under an anaerobic or inert atmosphere in order to convert this pasty mixture into synthesis gases and a solid reaction product containing at least chars and catalyst. Inside the pyrolysis reactor 5, an anaerobic and continuous pyrolysis or cracking reaction of the plastic materials occurs, promoted by the catalyst.

The pyrolysis reactor 5 internally incorporates a permeable bed 50 which is a fixed bed. This permeable bed 50 may for example be formed of a lattice composed of meshes delimiting holes, or alternatively be formed of heat transfer media. The meshes of the lattice or the heat transfer media are for example made of heat-resistant steel or ceramic.

The pyrolysis or cracking reaction therefore takes place between the plastic materials and the catalyst during contact with the permeable bed 50 heated within the pyrolysis reactor 5, in an anaerobic or inert atmosphere and with a fixed and stable pyrolysis temperature, for example comprised between 300 and 900° C. This reaction leads to the cracking and therefore depolymerization of the plastic materials.

The pyrolysis reactor 5 has a first outlet 51 located above the permeable bed 50 for discharge and recovery of the synthesis gases, and a second outlet 52 located below the permeable bed 50 for discharge and recovery of the solid reaction product. The second outlet 52 is for example provided at the base of the pyrolysis reactor 5, in the lower part of the pyrolysis reactor 5.

The exit of the synthesis gases is therefore performed on the first outlet 51 which is above the permeable bed 50 in order to promote settling of chars within the pyrolysis reactor 5, with the aim of avoiding the transfer of the chars to the first outlet 51 and thus not contaminating the synthesis gases.

The outlet 36 of the material diffuser 35 is linked to the top of the pyrolysis reactor 5 (in other words in the upper part of the pyrolysis reactor 5) and this material diffuser 35 provides a substantially homogeneous and uniform surface distribution of the pasty mixture inside the pyrolysis reactor 5 and on its permeable bed 50. Advantageously, the connection between the material diffuser 35 and the pyrolysis reactor 5 is made using a high-temperature sleeve, in order to be able to manage the expansions related to the temperature differences between the material diffuser 35 and the pyrolysis reactor 5, and thus preserve sealing.

The pyrolysis reactor 5 is associated with a burner 92 which is adjusted to heat a heat transfer fluid at the pyrolysis temperature, in order to heat the pyrolysis reactor 5 and its permeable bed 50 at the pyrolysis temperature.

According to a first possibility, the heat transfer fluid is present or circulates inside a double jacket of the pyrolysis reactor 5.

According to a second possibility (in addition to or as a variant of the first possibility mentioned above), the heat transfer fluid is present or circulates inside the permeable bed 50, and for example inside the meshes of the permeable bed 50 which are tubular.

Optionally, this pyrolysis reactor 5 incorporates or comprises a vibrator for submitting the permeable bed 50 to a vibration, in order to promote the detachment of the chars and the catalyst from the permeable bed 50, and thus their gravitational descent into the pyrolysis reactor 5.

The conversion installation 1 comprises a solid reaction product recovery line 6 connected to the second outlet 52 of the pyrolysis reactor 5 to recover and treat the solid reaction product which, as a reminder, comprises at least the chars and the catalyst; the catalyst, having participated in the pyrolysis reaction, is at least partially in a used state, in other words it comprises catalyst to be regenerated and, in a smaller proportion, new or unused catalyst.

This solid reaction product recovery line 6 comprises a regeneration reactor 60 connected to the second outlet 52 of the pyrolysis reactor 5, where this regeneration reactor 60 recovers the solid reaction product to heat it to a regeneration temperature allowing at least partial regeneration of the catalyst it contains. This regeneration reactor 60 therefore has the function of regenerating the used catalyst contained in the solid reaction product at the outlet of the pyrolysis reactor 5, with the aim of being able to reuse it.

This regeneration reactor 60 is a closed reactor, also called a “batch” reactor. The regeneration temperature is for example comprised between 300 and 900° C. to regenerate the catalyst and separate the regenerated catalyst and the chars.

As this regeneration reactor 60 is a closed reactor, and the solid reaction product continuously exists the pyrolysis reactor 5, it is advantageous to use a buffer device between the second outlet 52 of the pyrolysis reactor 5 and the regeneration reactor 60, such as for example a bimetallic gate valve to isolate the continuous work of the pyrolysis reactor 5 and the work cycles of the regeneration reactor 60.

This regeneration reactor 60 comprises a double jacket in which a heat transfer fluid heated by a burner 93 is present or circulates; this burner 93 being thus adjusted to heat the heat transfer fluid of the regeneration reactor 60 to the regeneration temperature.

This solid reaction product recovery line 6 comprises, at the outlet of the regeneration reactor 60, a separator 61 for performing a separation between the regenerated catalyst and the chars or a mixture containing the chars and non-regenerated catalyst. This separator 61 comprises a first outlet 62 for recovering the regenerated catalyst, and a second outlet 63 for recovering the chars or the mixture containing the chars and the non-regenerated catalyst.

It is advantageous to use another buffer device, this time between the regeneration reactor 60 and the separator 61, such as for example a bimetallic gate valve, to isolate the work cycles of the regeneration reactor 60 and the continuous work of the separator 61.

The conversion installation 1 comprises a return line 41 connecting the first outlet 62 of the separator 61 to the catalyst feed line 4 in order to reintroduce the regenerated catalyst inside the preheating reactor 3. More precisely, the return line 41 is part of the catalyst feed line 4, and this return line 41 connects the first outlet 62 of the separator 61 to the second inlet 37 of the preheating reactor 3, in order to introduce the regenerated catalyst inside the preheating reactor 3.

To the extent that the catalyst is not fully regenerated in the regeneration reactor 60 and/or is not fully separated and recovered at the outlet of the separator 61, the return line 41 is connected to the new catalyst storage volume 40 in order to mix the regenerated catalyst and the new catalyst before introduction into the preheating reactor 3. The catalyst feed line 4 thus comprises a metering screw 42 for metering and mixing the new catalyst with the regenerated catalyst in a predefined and controlled proportion.

The solid reaction product recovery line 6 comprises a collector 64, connected to the second outlet 63 of the separator 61 to collect the chars and the non-regenerated catalyst, this collector 64 being followed by a conveyor 65, such as for example an extraction screw 65, to convey the chars and the non-regenerated catalyst to a storage space 66. The chars thus collected may possibly be subject to treatment for valorization.

The conversion installation 1 comprises a synthesis gas recovery line 7 connected to the first outlet 51 of the pyrolysis reactor 5, the synthesis gases containing condensable gases and non-condensable gases. This synthesis gas recovery line 7 is thermally traced at the same temperature as that of the pyrolysis reactor 5, with the aim of avoiding premature condensation of the condensable gases into pyrolytic oils.

The synthesis gas recovery line comprises a filtration unit 70 for filtration of suspended particles contained in the synthesis gases, such as for example char particles or other types of dust.

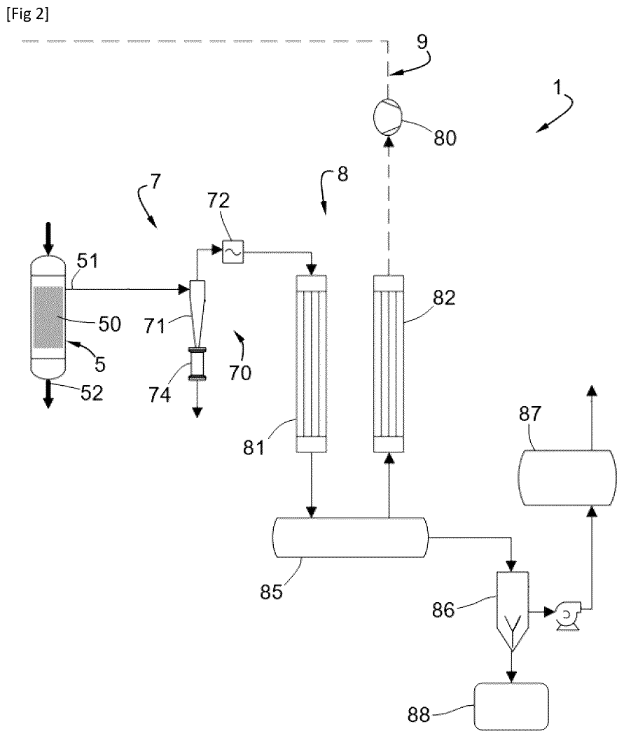

In the example of FIG. 2, this filtration unit 70 comprises a cyclone 71 for subjecting the synthesis gases to cyclonic filtration, and a micrometric filter, arranged downstream of the cyclone 71, for subjecting the synthesis gases to micrometric filtration; micrometric filtration being a finer filtration of the particles and contaminants remaining in the synthesis gases, compared to cyclonic filtration.

Furthermore, the cyclone 71 has at its base a particle discharge outlet, which is connected to a sealing device 74 to prevent air from entering the cyclone 71, and thus avoid mixing the synthesis gases with air.

This sealing device 74 may be for example in the form of a spool incorporating two successive valves for a dock seal type operation. Such a two-valve spool comprises a top valve upstream of the discharge outlet of the cyclone 71 and a bottom valve connected to a particle collection point. The two-valve spool operates as follows in a cyclic manner:
in a first phase, the top valve is open and the bottom valve is closed, to allow the particles to be discharged from the cyclone to the spool;
in a second phase, the top valve is closed and the bottom valve is opened, to allow the spool to be purged.

The opening and closing of the spool valves are managed by the level of particles present inside the cyclone 71; the spool purging being carried out cyclically.

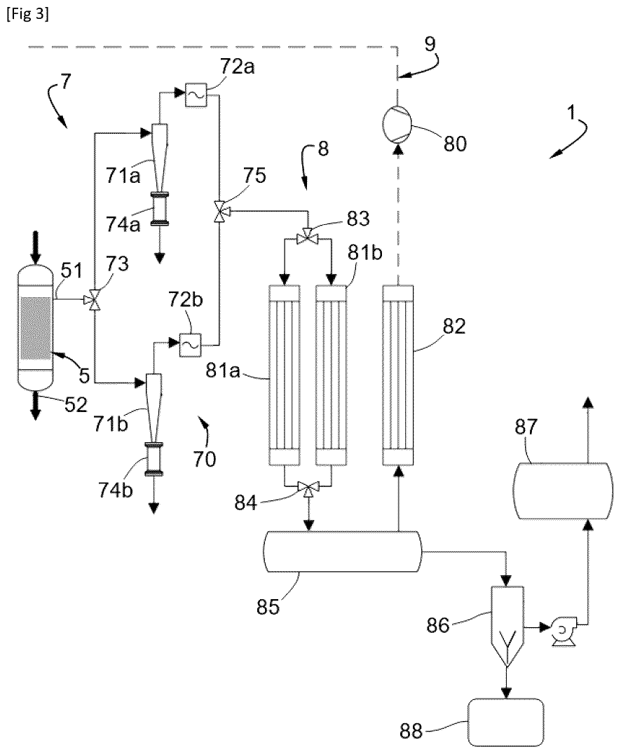

In the example of FIG. 3, this filtration unit 70 comprises a first cyclone 71a and a second cyclone 71b in parallel to subject the synthesis gases alternately to cyclonic filtration within the first cyclone 71a and to cyclonic filtration within the second cyclone 71b. A three-way valve 73 is arranged between the first outlet 51 of the pyrolysis reactor 5 and the two cyclones 71a, 71b, in order to direct the synthesis gases alternately towards the first cyclone 71a and towards the second cyclone 71b.

Furthermore, each of the two cyclones 71a, 71b has at its base a particle discharge outlet, which is connected to a sealing device 74a, 74b to prevent air from entering, such as for example a two-valve spool as described above.

In the example of FIG. 3, the filtration unit 70 further comprises a first micrometric filter 72a, downstream of the first cyclone 71a, and a second micrometric filter 72b, downstream of the second cyclone 71b, for subjecting the synthesis gases alternately to micrometric filtration within the first micrometric filter 72a and to micrometric filtration within the second micrometric filter 72b. Another three-way valve 75 is provided downstream of the first micrometric filter 72a and the second micrometric filter 72b.

The example of FIG. 3 is advantageous in terms of servicing. Indeed, since the process is continuous, the two cyclones 71a, 71b are interchangeable and operate alternately in order to promote the maintenance and cleaning cycles; when one of the two cyclones 71a, 71b is being cleaned, the other is active in purification mode.

Similarly, the two micrometric filters 72a, 72b are interchangeable and operate alternately in order to also promote the maintenance and cleaning cycles: when one of the two micrometric filters 72a, 72b is being cleaned, the other is active and in filtration mode.

The conversion installation 1 comprises a condensation line 8 arranged downstream of the synthesis gas recovery line 7 and configured to condense the condensable gases of the synthesis gases into pyrolytic oils.

The condensation line 8 successively comprises at least one primary condenser 81, 81a, 81b operating at a primary condensation temperature, and at least one secondary condenser 82 operating at a secondary condensation temperature, where this secondary condensation temperature is lower than the primary condensation temperature.

A thermal shock is required between the hot synthesis gases and the primary condenser(s) 81, 81a, 81b for the condensation phenomenon to take place. This step of the process causes condensation of the polymer chains present in the synthesis gases, in the form of pyrolytic oil and a water fraction. The proportions of condensing gases are controlled by regulating the cooling temperature of the primary condenser(s) 81, 81a, 81b. The condensation line 8 is thermally traced to the inlet of the primary condenser(s) 81, 81a, 81b, with the aim of avoiding premature condensation of the synthesis gases into pyrolytic oil before the primary condenser(s) 81, 81a, 81b.

In the example of FIG. 2, this condensation line 8 comprises a single primary condenser 81.

In the example of FIG. 3, this condensation line 8 comprises a first primary condenser 81a and a second primary condenser 81b in parallel to condense the condensable gases of the synthesis gases alternately in the first primary condenser 81a and in the second primary condenser 81b. A three-way inlet valve 83 is arranged upstream of the two primary condensers 81a, 81b, in order to direct the synthesis gases alternately towards the first primary condenser 81a and towards the second primary condenser 81b. A three-way outlet valve 84 is arranged downstream of the two primary condensers 81a, 81b.

Since the process is continuous, the two primary condensers 81a, 81b are interchangeable and operate alternately in order to promote maintenance and cleaning cycles: when one of the two primary condensers 81a, 81b is being cleaned, the other is active and in condensation mode.

The condensation line 8 comprises, between the primary condenser 81 or the primary condensers 81a, 81b and the secondary condenser 82, a settling tank 85 containing the pyrolytic oils and possibly the condensed water, resulting from the condensation in the primary condenser(s) 81, 81a, 81b.

The secondary condenser 82 is traversed by a temperature colder than that of the primary condenser(s) 81, 81a, 81b, and therefore this secondary condenser 82 causes a thermal shock greater than that used for the primary condenser(s) 81, 81a, 81b. Thus, this secondary condenser 82 allows condensation of the fraction of non-condensed gases following their passage in the primary condenser(s) 81, 81a, 81b. The shortest chains are therefore condensed in the secondary condenser 82 in the form of a new fraction of pyrolytic oil, obtained through the second condensation, and this new fraction of pyrolytic oil also returns to the settling tank 85.

The condensation line 8 comprises a vacuum pump 80, arranged downstream of the secondary condenser 82, in order to create a vacuum allowing suction into the secondary condenser 82 of the fraction of synthesis gases not condensed in the primary condenser(s) 81, 81a, 81b. Thus, this fraction undergoes a new condensation within the secondary condenser 82, as previously described. The vacuum pump 80 therefore makes it possible to ensure a vacuum in the circuit and to promote the arrival of the synthesis gases into the secondary condenser 82.

The condensation line 8 comprises, following the settling tank 85, a separator 86 for separating the pyrolytic oil fractions and potentially the condensed water fraction, in order to direct the pyrolytic oils into a homogenization tank 87 and the condensed water fraction to a water recovery tank 88. This separator 86 potentially makes it possible to isolate the water fraction contained in the plastic materials during the introduction on the continuous plastic material feed line 2.

The homogenization tank 87 thus brings together the different fractions of the pyrolytic oils, arriving from the settling tank 85, to perform homogenization of the pyrolytic oils before their storage.

Advantageously, the vacuum pump 80 is arranged on a non-condensable gas recovery line 9 on which a vacuum pump is arranged downstream of the at least one secondary condenser, for discharge of the non-condensable gases.

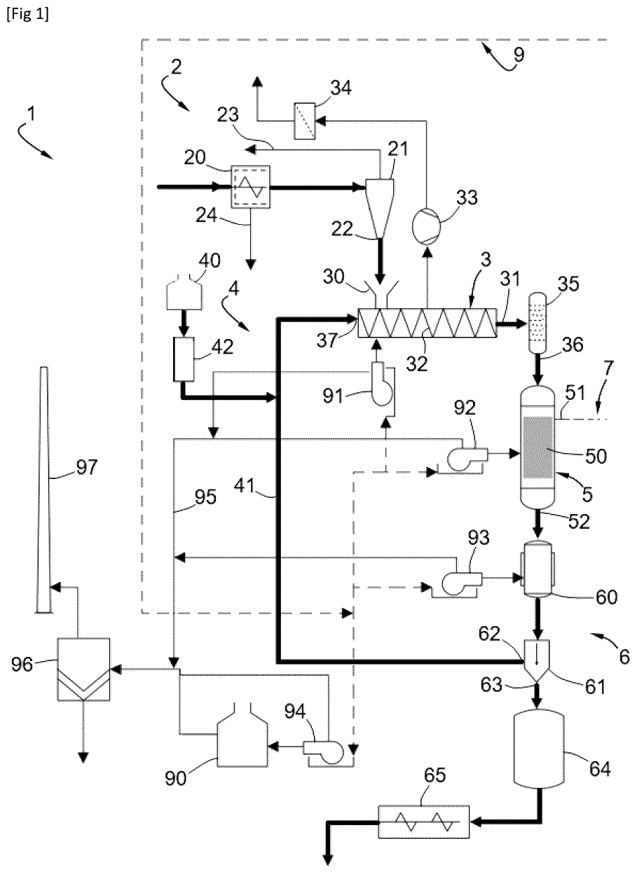

As can be seen in FIG. 1, this non-condensable gas recovery line 9 is linked to the burners 91, 92, 93 to convey the non-condensable gases into these burners 91, 92, 93 and thus feed these burners 91, 92, 93 at least partially with the non-condensable gases of the synthesis gases. In this way, the non-condensable gases resulting from the pyrolysis reaction serve as an energy source to thermally feed the preheating in the preheating reactor 3, the pyrolysis in the pyrolysis reactor 5, and the regeneration in the regeneration reactor 60. It is possible to supplement this gas supply to the burners 91, 92, 93 with another gas, such as for example a natural gas or propane.

It is possible to provide a boiler 90 provided with a burner 94 also fed with the non-condensable gases coming from this non-condensable gas recovery line 9; such a boiler 90 thus allows combustion of non-condensable gases and production of energy for applications external to the conversion installation 1.

In addition, the burners 91, 92, 93, 94 can be linked to a line 95 for recovering flue gas which is obtained during the combustion of the non-condensable gases by the burners 91, 92, 93, 94. This flue gas recovery line 95 is connected to a flue gas treatment unit 96 to subject this flue gas to treatment making it possible to purify it from the various sources of contaminants before being discharged into the atmosphere through a chimney 97. This flue gas treatment thus makes it possible to comply with the environmental guidelines for the emission of flue gas into the atmosphere while being part of a circular economy.

It should be noted that all the steps of the conversion process are performed in an anaerobic atmosphere (in the absence of oxygen). Inerting cycles (with nitrogen or other inert gases) can advantageously be performed in the various elements of the conversion installation 1, with the aim of driving out all the oxygen present in the plastic materials and in the catalyst, and discharging the synthesis gases remaining in the conversion installation 1.

1. A conversion process implementing degradation by pyrolysis of plastic materials for conversion into pyrolytic oils, said conversion process comprising at least the following phases:
the plastic materials are continuously fed into a preheating reactor in order to be mixed and preheated at a preheating temperature to fluidize them, and a catalyst is continuously fed into the preheating reactor to be mixed with the plastic materials and obtain a pasty mixture, the preheating temperature being lower than an activation temperature of the catalyst;
the pasty mixture is continuously transferred into a pyrolysis reactor to be heated at a pyrolysis temperature, higher than the preheating temperature and the activation temperature of the catalyst, under an anaerobic or inert atmosphere in order to be converted into synthesis gases and a solid reaction product containing at least chars, the pasty mixture descending by gravity inside the pyrolysis reactor and through a permeable bed which is heated at the pyrolysis temperature;
the synthesis gases, containing condensable gases and non-condensable gases, are recovered on a first outlet of the pyrolysis reactor located above the permeable bed, and the solid reaction product is recovered on a second outlet of the pyrolysis reactor located below the permeable bed;
the condensable gases of the synthesis gases are condensed into pyrolytic oils which are recovered.

2. The conversion process according to claim 1, wherein a step of degassing the pasty mixture inside the preheating reactor is implemented.

3. The conversion process according to claim 1, wherein, before being introduced inside the preheating reactor, the plastic materials are dry washed inside an inlet centrifuge, with air heated at a drying temperature lower than the preheating temperature.

4. The conversion process according to claim 1, wherein, inside the preheating reactor, the plastic materials are mixed by means of a worm screw.

5. The conversion process according to claim 1, wherein the preheating temperature is comprised between 20 and 290° C. inside the preheating reactor.

6. The conversion process according to claim 1, wherein, between the preheating reactor and the pyrolysis reactor, the pasty mixture passes into a material diffuser for a substantially homogeneous and uniform surface distribution of the pasty mixture inside the pyrolysis reactor, said material diffuser being heated at a diffusion temperature higher than or equal to the preheating temperature and lower than the pyrolysis temperature.

7. The conversion process according to claim 1, wherein the permeable bed is subjected to vibration.

8. The conversion process according to claim 1, wherein the permeable bed is a fixed bed.

9. The conversion process according to claim 1, wherein the permeable bed is formed of a lattice composed of meshes delimiting holes, for example made of heat-resistant steel or ceramic.

10. The conversion process according to claim 1, wherein the pyrolysis temperature is stable and comprised between 300 and 900° C.

11. The conversion process according to claim 1, wherein the solid reaction product, recovered on the second outlet of the pyrolysis reactor, is introduced into a closed regeneration reactor for heating the solid reaction product to a regeneration temperature allowing at least partial regeneration of the catalyst it contains.

12. The conversion process according to claim 11, wherein, at the outlet of the closed regeneration reactor, the solid reaction product is introduced into a separator to perform a separation between regenerated catalyst and the chars or a mixture containing the chars and non-regenerated catalyst, the regenerated catalyst being reintroduced inside the preheating reactor.

13. The conversion process according to claim 12, wherein, before its introduction inside the preheating reactor the regenerated catalyst is mixed with a new catalyst.

14. The conversion process according to claim 1, wherein the synthesis gases, recovered on the first outlet of the pyrolysis reactor, are introduced into a filtration unit for filtration of suspended particles contained in the synthesis gases, before condensation of the condensable gases of the synthesis gases.

15. The conversion process according to claim 14, wherein the synthesis gases are subjected to cyclonic filtration within at least one cyclone of the filtration unit.

16. The conversion process according to claim 15, wherein the synthesis gases are subjected alternately to cyclonic filtration within a first cyclone of the filtration unit and to cyclonic filtration within a second cyclone of the filtration unit, the at least one cyclone of the filtration unit comprising said first cyclone and said second cyclone in parallel.

17. The conversion process according to claim 15, wherein, after the cyclonic filtration, the synthesis gases are subjected to micrometric filtration within at least one micrometric filter of the filtration unit.

18. The conversion process according to claim 17, wherein the synthesis gases are subjected alternately to micrometric filtration within a first micrometric filter of the filtration unit and to micrometric filtration within a second micrometric filter of the filtration unit, the at least one micrometric filter of the filtration unit (70) comprising said first micrometric filter and said second micrometric filter in parallel.

19. The conversion process according to claim 1, wherein the condensable gases of the synthesis gases are condensed in at least one primary condenser operating at a primary condensation temperature, then in at least one secondary condenser operating at a secondary condensation temperature, said secondary condensation temperature being lower than the primary condensation temperature.

20. The conversion process according to claim 19, wherein, before condensation in the at least one secondary condenser, the condensable gases of the synthesis gases are condensed alternately in a first primary condenser and in a second primary condenser, the at least one primary condenser comprising said first primary condenser and said second primary condenser in parallel.

21. A plastic pyrolysis process according to claim 19, wherein a vacuum pump, arranged downstream of the at least one secondary condenser provides suction of the synthesis gases into the at least one secondary condenser and discharge of the non-condensable gases on a non-condensable gas recovery line.

22. A conversion installation for degradation by pyrolysis of plastic materials for conversion into pyrolytic oils, said conversion installation comprising at least:
a continuous plastic material feed line;
a catalyst feed line;
a preheating reactor connected to the continuous plastic material feed line and to the catalyst feed line, said preheating reactor being configured to mix the plastic materials and preheat them at a preheating temperature in order to fluidize them, and to mix the plastic materials with the catalyst in order to obtain a pasty mixture, the preheating temperature being lower than an activation temperature of the catalyst;
a pyrolysis reactor arranged downstream of the preheating reactor and configured to heat the pasty mixture at a pyrolysis temperature, higher than the preheating temperature and the activation temperature of the catalyst, under an anaerobic or inert atmosphere in order to be converted into synthesis gases and a solid reaction product containing at least chars, the pyrolysis reactor internally incorporating a permeable bed, a first outlet located above the permeable bed and a second outlet located below the permeable bed;
a synthesis gas recovery line connected to the first outlet of the pyrolysis reactor (5), the synthesis gases containing condensable gases and non-condensable gases;
a solid reaction product recovery line connected to the second outlet of the pyrolysis reactor;
a condensation line arranged downstream of the synthesis gas recovery line and configured to condense the condensable gases of the synthesis gases into pyrolytic oils.

23. The conversion installation according to claim 22, comprising an air pump connected to the preheating reactor for degassing the pasty mixture inside the preheating reactor.

24. The conversion installation according to claim 22, wherein the continuous plastic material feed line comprises, upstream of the preheating reactor, an inlet centrifuge for dry washing the plastic materials, with air heated at a drying temperature lower than the preheating temperature.

25. The conversion installation according to claim 22, comprising, between the preheating reactor and the pyrolysis reactor, a material diffuser for a substantially homogeneous and uniform surface distribution of the pasty mixture inside the pyrolysis reactor, said material diffuser being heated at a diffusion temperature higher than or equal to the preheating temperature and lower than the pyrolysis temperature.

26. The conversion installation according to claim 22, comprising a closed regeneration reactor connected to the second outlet of the pyrolysis reactor, for heating the solid reaction product to a regeneration temperature allowing at least partial regeneration of the catalyst it contains.

27. The conversion installation according to claim 26, comprising, at the outlet of the closed regeneration reactor, a separator for performing a separation between regenerated catalyst and the chars or a mixture containing the chars and non-regenerated catalyst, the separator comprising a first outlet for the regenerated catalyst and a second outlet for the chars or the mixture containing the chars and the non-regenerated catalyst.

28. The conversion installation according to claim 22, wherein the condensation line comprises at least one primary condenser operating at a primary condensation temperature, and at least one secondary condenser operating at a secondary condensation temperature, said secondary condensation temperature being lower than the primary condensation temperature.
